(19) United States
(12) Patent Application Publication
(10) Pub. No.: US 2025/0185841 A1
(43) Pub. Date: Jun. 12, 2025

(54) COFFEE MACHINE AND A COFFEE LIQUID EXTRACTION METHOD

(71) Applicant: Wuxi Huozhong Power Equipment Co., Ltd, Wuxi (CN)

(72) Inventor: Liang CHEN, Wuxi (CN)

(73) Assignee: Wuxi Huozhong Power Equipment Co., Ltd, Wuxi (CN)

(21) Appl. No.: 18/948,336

(22) Filed: Nov. 14, 2024

(30) Foreign Application Priority Data
Dec. 11, 2023 (CN) 202311690675.9

(51) Int. Cl. A47J 31/46; A47J 31/42; A47J 31/44

(52) U.S. Cl. CPC A47J 31/468; A47J 31/42; A47J 31/446; A47J 31/461

(57) ABSTRACT

The present invention discloses a coffee machine and a coffee liquid extraction method, wherein the coffee machine comprises: a coffee machine host with a worktable; a filter basket assembly configured to perform reciprocating motion on the worktable and including a filter basket for holding coffee powder; a group head disposed above the filter basket assembly; a tamping mechanism adjacent to the group head for compressing coffee powder within the filter basket; a coffee powder feeding mechanism for delivering coffee powder into the filter basket; a coffee bean grinding mechanism for grinding beans into grounds and supplying them to the feeding mechanism; a water supply device connected to the group head, which includes a piston pump unit with two pistons that alternately drive hot water through a pipeline into the group head; the group head extracts coffee from the grounds in the filter basket directly below it.

### TECHNICAL FIELD

The present invention relates to the technical field of coffee machines, specifically to a coffee machine and a coffee liquid extraction method.

### BACKGROUND TECHNOLOGY

Most existing coffee machines on the market are separate coffee bean grinders and coffee powder brewers, meaning the two operate independently. When users want to enjoy freshly ground coffee, they need to prepare both a coffee bean grinder and a coffee powder brewer, which involves adjusting grinding parameters, extraction pressure, continuous hot water supply, and other issues. This can cause significant inconvenience to users. Additionally, having to prepare two machines simultaneously leads to problems of occupying a lot of space. Moreover, when users use a coffee bean grinder and a coffee powder brewer, they cannot control the optimal ratio of coffee powder to water; if the ratio is not optimal, it can greatly affect the taste.

### SUMMARY OF THE INVENTION

To at least solve the above technical problems, the object of the present invention is to provide a coffee machine that integrates the functions of grinding coffee beans and extracting coffee liquid.

To achieve the above object, the coffee machine provided by the present application includes: a coffee machine host, provided with a worktable on the coffee machine host; a filter basket assembly that performs reciprocating motion on the worktable; the filter basket assembly includes a filter basket used for holding coffee powder; a group head, arranged above the filter basket assembly; a tamping mechanism, arranged on the side of the group head; the tamping mechanism is used to compress the coffee powder within the filter basket; the coffee machine host further includes: a coffee powder feeding mechanism and a coffee bean grinding mechanism; the coffee powder feeding mechanism is used to deliver coffee powder into the filter basket; the coffee bean grinding mechanism is used to grind coffee beans into coffee powder and deliver the coffee powder into the coffee powder feeding mechanism; a water supply device, connected to the group head; the water supply device further includes: a piston pump unit, which is connected to the water supply pipeline; the piston pump unit includes two pistons that alternately drive hot water in the water supply pipeline into the group head; the group head is used to extract the coffee powder in the filter basket that has moved directly below the group head.

Further, the group head includes a first group head and a second group head; the first group head and the second group head are arranged on both sides of the tamping mechanism.

Further, the worktable is provided with guide rails, and the filter basket assembly performs reciprocating motion on the guide rails; the worktable is provided with a through-hole located below the group head.

Further, the filter basket includes a basket base and a basket wall; the basket base has a mesh base; the basket wall is liftable; when the basket wall rises from within the filter basket assembly, the basket wall and the basket base together form the filter basket; after the basket wall descends, it is hidden within the filter basket assembly; the filter basket includes a single wall filter basket and a double wall filter basket.

Further, the filter basket assembly is provided with a filter basket through-hole; when the filter basket moves directly below the group head, the filter basket through-hole connects with the through-hole.

Further, the water supply device includes a heating block and a water supply pipeline; the water supply pipeline passes through the heating block in an S-shape; multiple heating rods are arranged on the heating block; the multiple heating rods are evenly distributed around the water supply pipeline.

Further, the water outlet of the group head is shaped like a showerhead.

To achieve the above object, the present application also provides a coffee liquid extraction method, using the above coffee machine, comprising: receiving an instruction to extract coffee liquid;
grinding coffee beans and heating a corresponding volume of hot water according to the instruction to extract coffee liquid;
determining whether there is coffee residue on the basket base below the tamping mechanism: if the result is yes, the coffee powder feeding mechanism pushes the coffee residue off the basket base; if the result is no, the basket wall corresponding to the basket base rises, and the coffee powder feeding mechanism delivers coffee powder of the weight corresponding to the extraction instruction into the filter basket;
the tamping mechanism compresses the coffee powder in the filter basket into a coffee puck;
the filter basket moves to an idle group head below;
the hot water passes through the group head to extract the coffee puck.

Further, when the coffee powder feeding mechanism has obtained the coffee powder of the weight corresponding to the extraction instruction, the coffee bean grinding mechanism stops grinding coffee beans.

Further, extracting the coffee puck with the group head includes: the group head performs drip filtration or spraying on the coffee puck.

In the coffee machine provided by the embodiment of the present invention, including: a coffee machine host, provided with a worktable on the coffee machine host; a filter basket assembly that performs reciprocating motion on the worktable; the filter basket assembly includes a filter basket used for holding coffee powder; a group head, arranged above the filter basket assembly; a tamping mechanism, arranged on the side of the group head; the tamping mechanism is used to compress the coffee powder within the filter basket; the coffee machine host further includes: a coffee powder feeding mechanism and a coffee bean grinding mechanism; the coffee powder feeding mechanism is used to deliver coffee powder into the filter basket; the coffee bean grinding mechanism is used to grind coffee beans into coffee powder and deliver the coffee powder into the coffee powder feeding mechanism; a water supply device, connected to the group head; the water supply device further includes: a piston pump unit, which is connected to the water supply pipeline; the piston pump unit includes two pistons that alternately drive hot water in the water supply pipeline; the group head is used to extract the coffee powder in the filter basket that has moved directly below the group head.

This coffee machine integrates the functions of grinding coffee beans and extracting coffee liquid, greatly satisfying users' demand for freshly ground coffee. The design of dual group heads and dual filter baskets significantly reduces user waiting time. By designing the tamper and group head separately, it avoids issues where integrating the tamper and group head could cause water to stick to the tamper, leading to pits on the surface of the coffee puck during the next compression, thereby affecting the quality of the next coffee liquid. The design of the heating block and heating rods makes temperature control of the water more precise, improves heating efficiency, and ensures the optimal water temperature for coffee extraction. The group head's water outlet is designed like a showerhead or mesh, increasing the contact area between the coffee puck and hot water for better extraction results. Setting a fan below the lower grinding blade effectively prevents the quality issue of coffee powder being damaged due to heat generated during grinding. Precise control of the coffee powder' weight meets user requirements while avoiding waste, saving resources.

### BRIEF DESCRIPTION OF THE DRAWINGS

The drawings are provided to offer further understanding of the present application and constitute a part of the specification. They are used to explain the present application together with the embodiments and do not constitute a limitation of the present application. In the drawings:

FIG. 1 is a schematic structural diagram of the coffee machine according to an embodiment of the present application;

FIG. 2 is a schematic structural diagram of another embodiment of the coffee machine according to the present application;

FIG. 3 is an exploded structural diagram of the coffee bean grinding mechanism according to an embodiment of the present application;

FIG. 4 is a schematic structural diagram of the gap adjustment gear plate according to an embodiment of the present application;

FIG. 5 is a schematic structural diagram of the upper grinding blade connecting seat according to an embodiment of the present application;

FIG. 6 is a schematic structural diagram of the grinding blade according to an embodiment of the present application;

FIG. 7 is an exploded structural diagram of the piston pump according to an embodiment of the present application;

FIG. 8 is a schematic structural diagram of the camshaft according to an embodiment of the present application;

FIG. 9 is a cross-sectional schematic diagram showing the structure when the water flow channel assembly matches with the water valve group according to an embodiment of the present application;

FIG. 10 is a flowchart showing the coffee liquid extraction method according to an embodiment of the present application.

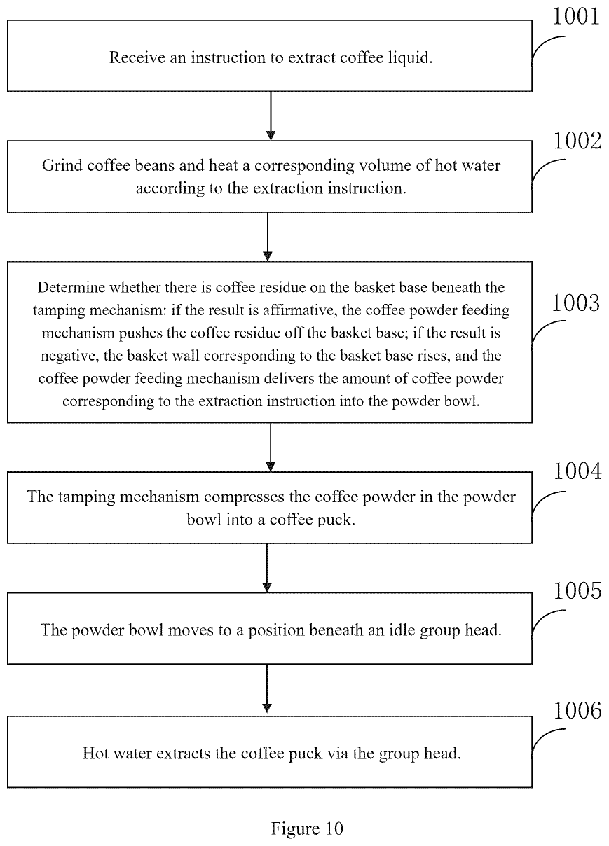

### REFERENCE NUMERALS

101—Coffee machine host; 102—Worktable; 103—Filter basket assembly; 104—Single wall filter basket; 105—Double wall filter basket; 106—First group head; 107—Tamping mechanism; 108—Coffee bean grinding mechanism; 109—Coffee powder feeding mechanism; 110—Coffee powder delivery channel; 111—Second group head; 112—Residue storage tank; 201—Water storage tank; 202—Heating block; 203—Piston pump unit; 301—Upper lid; 302—Gap adjustment gear plate; 303—Upper housing; 304—Gap adjustment motor; 305—Upper grinding blade connecting seat; 306—Upper grinding blade; 307—Lower grinding blade; 308—Main housing; 309—Outlet; 310—Fan; 311—Lower housing; 312—Power shaft; 401—Pin; 501—Pin slot; 502—Positioning pin; 601—Blade; 701—Camshaft; 702—Second piston; 703—Water pump driving motor; 704—Water pump driving module; 705—Water valve group; 706—Heating rod; 707—Water flow channel assembly; 708—First piston; 801—Annular guide rail; 802—Slider; 803—Fixed block; 901—Water inlet; 902—First outlet valve; 903—First inlet valve; 904—Second inlet valve; 905—Second outlet valve; 906—Pressure sensor; 907—Water outlet; 90—First chamber; 909—Second chamber.

### DETAILED DESCRIPTION

Below, the embodiments of the present application will be described in more detail with reference to the accompanying drawings. Although certain embodiments of the present application are shown in the drawings, it should be understood that the present application can be implemented in various forms and should not be construed as limited to the embodiments set forth herein. Rather, these embodiments are provided to make the present application more thorough and complete, and to fully convey the scope of the application to those skilled in the technology. It should be understood that the accompanying drawings and embodiments are provided for illustrative purposes only and are not intended to limit the scope of protection of the present application.

It should be understood that the various steps described in the method embodiments of the present application can be performed in different orders and/or executed concurrently. In addition, the method embodiments may include additional steps and/or omit the execution of certain steps shown. The scope of the present application is not limited in this regard.

The term “comprising” and its variations as used herein are open-ended terms meaning “including but not limited to.” The term “based on” means “at least partially based on.” The term “an embodiment” means “at least one embodiment”; the term “another embodiment” means “at least one other embodiment”; the term “some embodiments” means “at least some embodiments.” Relevant definitions of other terms will be provided in the descriptions below.

It should be noted that the modifiers “a,” “an,” and “multiple” mentioned in this application are illustrative and not limiting. Those skilled in the technology should understand that unless explicitly stated otherwise in context, they should be understood as “one or more.” “Multiple” should be understood as two or more.

Below, the embodiments of the present application will be described in detail with reference to the accompanying drawings.

The coffee machine provided by the embodiment of the present invention includes: a coffee machine host, with a worktable provided on the coffee machine host; a filter basket assembly, the filter basket assembly performs reciprocating motion on the worktable; the filter basket assembly includes a filter basket, which is used to hold coffee powder; a group head arranged above the filter basket assembly; a tamping mechanism arranged on the side of the group head; the tamping mechanism is used to compress the coffee powder within the filter basket; the coffee machine host further includes: a coffee powder feeding mechanism and a coffee bean grinding mechanism; the coffee powder feeding mechanism is used to deliver coffee powder into the filter basket; the coffee bean grinding mechanism is used to grind coffee beans into coffee powder and deliver the coffee powder into the coffee powder feeding mechanism; a water supply device, connected to the group head; the water supply device further includes: a piston pump unit, which is connected to the water supply pipeline; the piston pump unit includes two pistons, which alternately drive hot water in the water supply pipeline into the group head; the group head is used to extract the coffee powder in the filter basket that moves directly below the group head.

### Embodiment 1

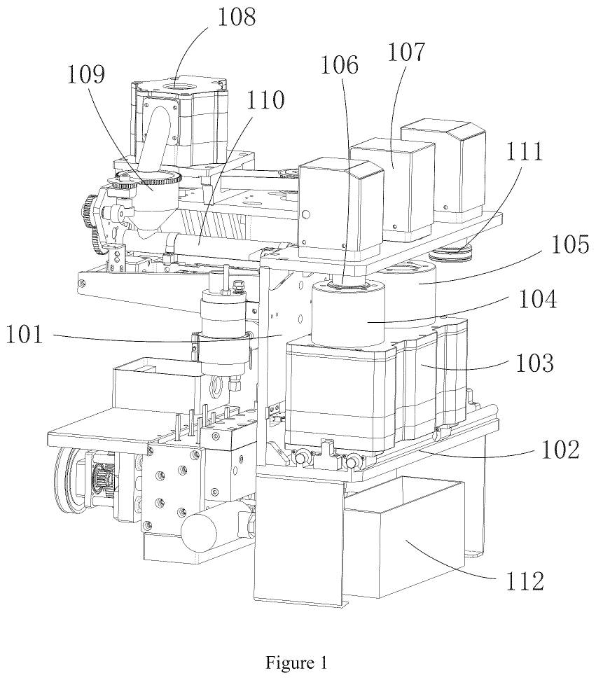

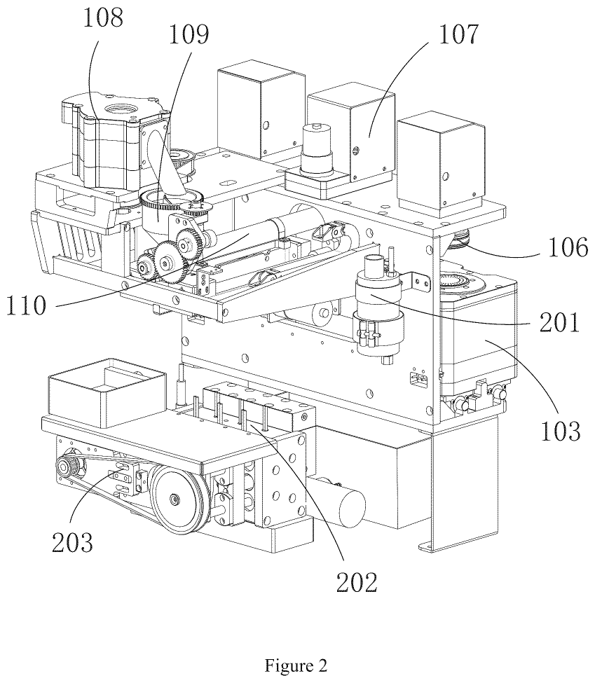

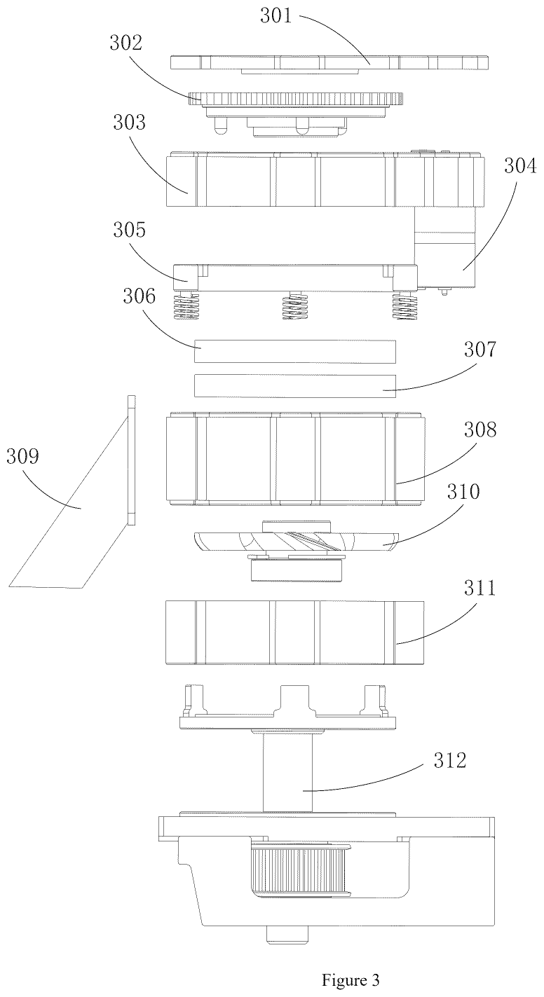

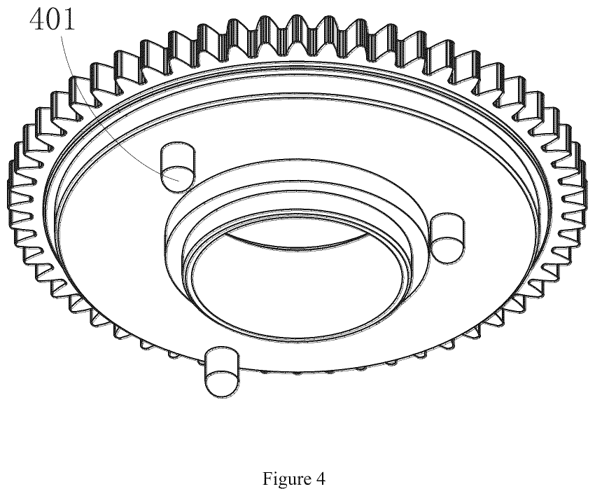

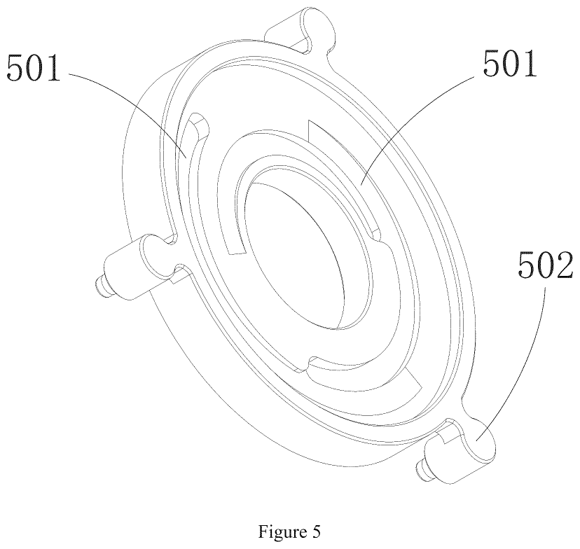

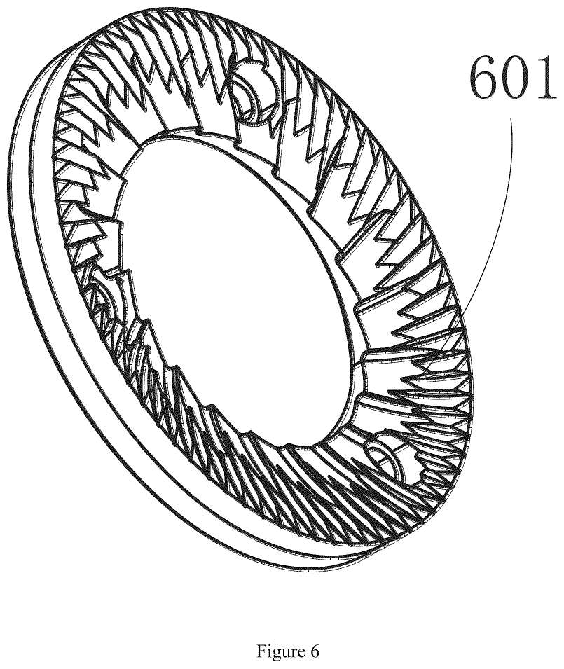

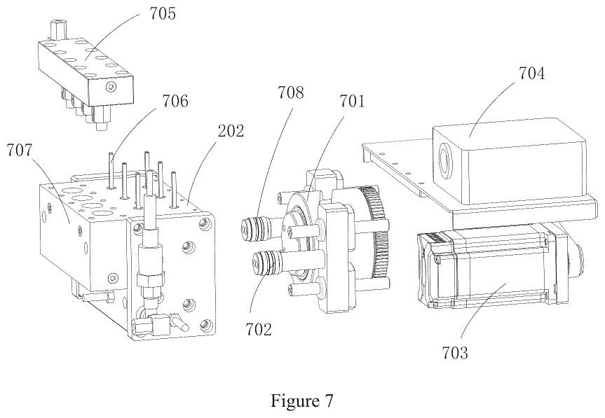

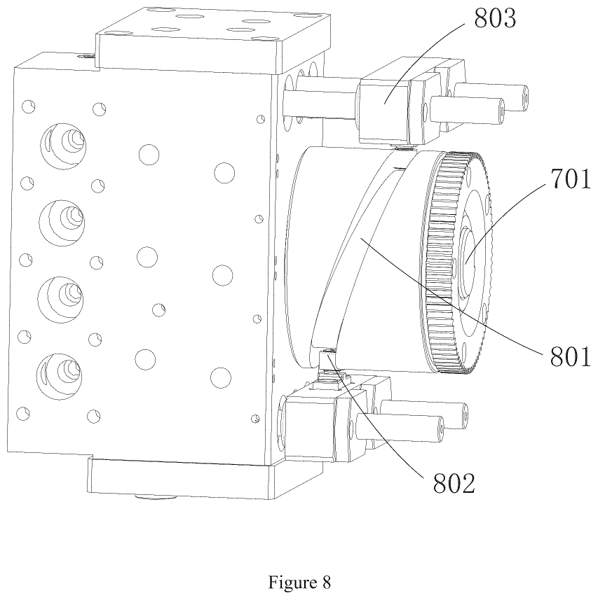

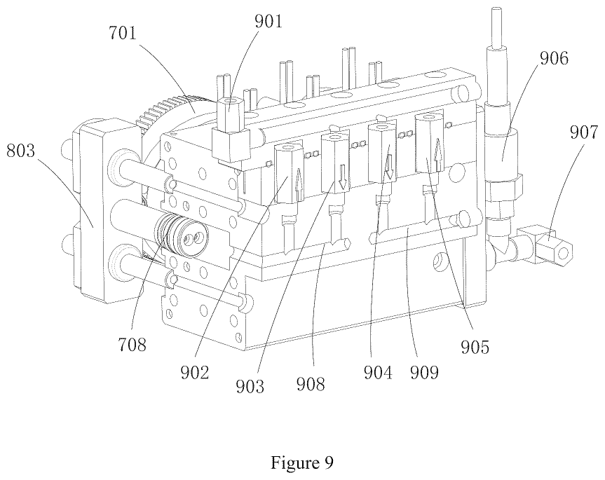

FIG. 1 is a schematic structural diagram of the coffee machine according to an embodiment of the present application. FIG. 2 is a schematic structural diagram of another embodiment of the coffee machine according to the present application. FIG. 3 is an exploded structural diagram of the coffee bean grinding mechanism according to an embodiment of the present application. FIG. 4 is a schematic structural diagram of the gap adjustment gear plate according to an embodiment of the present application. FIG. 5 is a schematic structural diagram of the upper grinding blade connecting seat according to an embodiment of the present application. FIG. 6 is a schematic structural diagram of the grinding blade according to an embodiment of the present application. FIG. 7 is an exploded structural diagram of the piston pump according to an embodiment of the present application. FIG. 8 is a schematic structural diagram of the camshaft according to an embodiment of the present application. FIG. 9 is a cross-sectional schematic diagram illustrating the structure when the water flow channel assembly matches with the water valve group according to an embodiment of the present application. Below, with reference to FIGS. 1 to 9, the coffee machine according to embodiments of the present invention will be described in detail.

In an exemplary embodiment, the coffee machine of the present application includes: a coffee machine host 101, which can be understood as the carrier for other components.

In an exemplary embodiment, a worktable 102 is provided on the coffee machine host 101.

In an exemplary embodiment, guide rails are provided on the worktable 102.

In an exemplary embodiment, the guide rails can be two in number as needed; of course, the number of guide rails is not less than two.

In an exemplary embodiment, stoppers are also provided at both ends of the worktable 102; of course, as needed, stoppers can also be provided at both ends of the guide rails.

In an exemplary embodiment, the coffee machine of the present application further includes: a filter basket assembly 103.

In an exemplary embodiment, the filter basket assembly 103 performs reciprocating motion on the worktable 102.

In an exemplary embodiment, the bottom of the filter basket assembly 103 is provided with attachments matching the guide rails on the worktable 102, such as sliders or slide grooves; the filter basket assembly 103 can move back and forth on the worktable 102.

In an exemplary embodiment, the purpose of setting the stoppers is to prevent the filter basket assembly 103 from disengaging from the ends of the guide rails.

In an exemplary embodiment, the filter basket assembly 103 includes a filter basket.

In an exemplary embodiment, the filter basket is used to hold coffee powder; it can be understood that the coffee powder need to be placed in the filter basket for extraction.

In an exemplary embodiment, the filter basket comprises a basket base and a basket wall.

In an exemplary embodiment, the basket base has a mesh base, which allows the coffee liquid to flow out through the basket base during subsequent extraction.

In an exemplary embodiment, the basket wall is liftable.

In an exemplary embodiment, when the basket wall rises from within the filter basket assembly 103, the basket wall and the basket base together form the filter basket.

In an exemplary embodiment, after the basket wall descends, it is hidden within the filter basket assembly 103; it can be understood that when the basket wall is completely hidden within the filter basket assembly 103, the basket base is exposed on the upper surface of the filter basket assembly 103.

In an exemplary embodiment, optionally, the basket wall further includes a heating layer. The heating layer is used to heat and maintain the temperature of the basket wall, so that the temperature of the coffee liquid can always be maintained at an optimal state—for example, keeping the coffee liquid at 92° C. to 94° C.

In an exemplary embodiment, as needed, the surface of the basket base can be flush with the upper surface of the filter basket assembly 103.

In an exemplary embodiment, the filter basket includes a single wall filter basket 104 and a double wall filter basket 105; it can be understood that two filter baskets are provided on the filter basket assembly 103.

In an exemplary embodiment, the line connecting the centers of the single wall filter basket 104 and the double wall filter basket 105 is parallel to the guide rails.

In an exemplary embodiment, a filter basket through-hole is provided below the filter basket assembly 103; it can be understood that after extraction, the coffee liquid flows downward through the basket base and finally flows out from inside the filter basket assembly 103 through the filter basket through-hole.

In an exemplary embodiment, the coffee machine of the present application further includes: a group head.

In an exemplary embodiment, the group head is arranged above the filter basket assembly 103.

In an exemplary embodiment, the group head is used to extract the coffee powder in the filter basket located directly below the group head.

In an exemplary embodiment, the water outlet of the group head is shaped like a showerhead or mesh.

In an exemplary embodiment, the coffee machine of the present application further includes: a tamping mechanism 107.

In an exemplary embodiment, the tamping mechanism 107 is located above the worktable 102.

In an exemplary embodiment, the tamping mechanism 107 is arranged on the side of the group head.

In an exemplary embodiment, when there are two group heads, the tamping mechanism 107 is located between the two group heads.

In an exemplary embodiment, the tamping mechanism 107 is used to compress the coffee powder in the filter basket.

In an exemplary embodiment, optionally, when the filter basket enters beneath the tamping mechanism 107, the basket wall may initially be hidden within the filter basket assembly 103, and the basket wall will rise only when there is no coffee residue on the basket base. Of course, the basket wall may also be in a raised state when the filter basket enters beneath the tamping mechanism 107, and then descend and hide after entering beneath the tamping mechanism 107; the basket wall will rise only when there is no coffee residue on the basket base.

In an exemplary embodiment, the group head includes multiple group heads arranged on both sides or on the same side of the tamping mechanism 107.

In an exemplary embodiment, the group head includes a first group head 106 and a second group head 111.

In an exemplary embodiment, the first group head 106 and the second group head 111 are arranged on both sides of the tamping mechanism 107.

In an exemplary embodiment, the line connecting the centers of the first group head 106 and the second group head 111 is parallel to the line connecting the centers of the single wall filter basket 104 and the double wall filter basket 105.

In an exemplary embodiment, the distances from the first group head 106 and the second group head 111 to the tamping mechanism 107 are equal.

In an exemplary embodiment, the distance between the single wall filter basket 104 and the double wall filter basket 105 is half the distance between the first group head 106 and the second group head 111; that is, when the single wall filter basket 104 is located beneath the first group head 106, the double wall filter basket 105 is exactly beneath the tamping mechanism 107; when the single wall filter basket 104 is beneath the tamping mechanism 107, the double wall filter basket 105 is exactly beneath the second group head 111.

In an exemplary embodiment, the lower end of the tamping mechanism 107 is provided with a tamper.

In an exemplary embodiment, the shape and size of the tamper match those of the filter basket.

In an exemplary embodiment, the lower surface of the tamper is smooth and flat; of course, if necessary, the lower surface of the tamper can also be designed with convex and concave features.

In an exemplary embodiment, the downward force of the tamper is approximately 15 kilograms.

In an exemplary embodiment, the purpose of compressing the coffee powder in the filter basket is to flatten the coffee powder and press them into a puck shape; it can be understood that during the final extraction of the coffee liquid, the extraction is performed on the coffee puck, rather than directly on loose coffee powder.

In an exemplary embodiment, the outlet of the group head is designed in a showerhead or mesh shape, so that the coffee puck has a larger contact area with hot water, resulting in a better extraction effect.

In an exemplary embodiment, the extraction method may involve the group head injecting hot water into the filter basket by dripping or spraying onto the coffee puck.

In an exemplary embodiment, optionally, the group head can also be designed to move up and down, i.e., the group head has a lifting function, making the distance between the group head and the coffee puck smaller for a better hot water extraction effect.

In an exemplary embodiment, optionally, the group head further includes a heating module for heating the group head.

In an exemplary embodiment, the coffee machine of the present application further includes a coffee bean grinding mechanism 108.

In an exemplary embodiment, the coffee bean grinding mechanism 108 is arranged at the rear of the coffee machine host 101.

In an exemplary embodiment, the coffee bean grinding mechanism 108 is used to grind coffee beans into coffee powder.

In an exemplary embodiment, the coffee bean grinding mechanism 108 further includes delivering the coffee powder into the coffee powder feeding mechanism 109.

In an exemplary embodiment, the coffee bean grinding mechanism 108 is provided with a coffee bean inlet, and coffee beans enter the coffee bean grinding mechanism 108 through the coffee bean inlet.

In an exemplary embodiment, the upper lid 301 is a component provided with a through-hole; for example, the upper lid 301 has a through-hole in the middle, and coffee beans are introduced into the coffee bean grinding mechanism 108 through the through-hole in the upper lid 301.

In an exemplary embodiment, a gap adjustment gear plate 302 is provided below the upper lid 301.

In an exemplary embodiment, pins 401 are provided below the gap adjustment gear plate 302, and the pins 401 protrude from the lower surface of the gap adjustment gear plate 302.

In an exemplary embodiment, there are multiple pins 401, which are located along the circumference of the same circle.

In an exemplary embodiment, the pins 401 are cylindrical, for example.

In an exemplary embodiment, the multiple pins 401 are equally spaced.

In an exemplary embodiment, for example, there are three pins 401.

In an exemplary embodiment, the gap adjustment gear plate 302 is provided with a through-hole; for example, the gap adjustment gear plate 302 has a through-hole in the middle, which connects with the through-hole in the upper lid 301.

In an exemplary embodiment, the gap adjustment gear plate 302 is also provided with gears; for example, gears are arranged on the outer circumference of the gap adjustment gear plate 302.

In an exemplary embodiment, the coffee bean grinding mechanism 108 is further provided with an upper housing 303.

In an exemplary embodiment, the upper housing 303 is a barrel-shaped structure that extends vertically through.

In an exemplary embodiment, the upper housing 303 is provided with a through-hole.

In an exemplary embodiment, the gap adjustment gear plate 302 is arranged between the upper lid 301 and the upper housing 303; it can be understood that the gap adjustment gear plate 302 is located within the through-hole of the upper housing 303, or in other words, the gap adjustment gear plate 302 is arranged inside the upper housing 303.

In an exemplary embodiment, the coffee bean grinding mechanism 108 further includes a gap adjustment motor 304; for example, the gap adjustment motor 304 is arranged on the side of the upper housing 303.

In an exemplary embodiment, the gap adjustment motor 304 adjusts the rotation of the gap adjustment gear plate 302 through the gears on the gap adjustment gear plate 302.

In an exemplary embodiment, optionally, transmission gears may also be included between the gap adjustment motor 304 and the gap adjustment gear plate 302, which can be multiple.

In an exemplary embodiment, an upper grinding blade connecting seat 305 is provided below the gap adjustment gear plate 302.

In an exemplary embodiment, the upper surface of the upper grinding blade connecting seat 305 is provided with pin slots 501.

In an exemplary embodiment, there are multiple pin slots 501, for example, an odd number.

In an exemplary embodiment, the pin slots 501 are arc-shaped.

In an exemplary embodiment, the multiple pin slots 501 are located along the circumference of the same circle.

In an exemplary embodiment, the depth of the pin slots 501 varies gradually from deep to shallow in an arc-shaped groove.

In an exemplary embodiment, the pin slots 501 match with the pins 401.

In an exemplary embodiment, the number of pin slots 501 is the same as the number of pins 401.

In an exemplary embodiment, a through-hole is provided in the middle of the upper grinding blade connecting seat 305, which matches the through-hole on the gap adjustment gear plate 302.

In an exemplary embodiment, a grinding blade is provided on the lower surface of the upper grinding blade connecting seat 305.

In an exemplary embodiment, the grinding blade includes an upper grinding blade 306 and a lower grinding blade 307.

In an exemplary embodiment, the lower surface of the upper grinding blade 306 and the upper surface of the lower grinding blade 307 are both provided with blades 601; that is, the grinding blades have blades 601 on one side.

In an exemplary embodiment, the upper grinding blade 306 and the lower grinding blade 307 are arranged symmetrically up and down.

In an exemplary embodiment, the blades on the upper grinding blade 306 and the lower grinding blade 307 are arranged sequentially in a ring shape around the center.

In an exemplary embodiment, the blades on the upper grinding blade 306 and the lower grinding blade 307 are uniformly distributed.

In an exemplary embodiment, the cutting edges of the blades on the upper grinding blade 306 face the cutting edges of the blades on the lower grinding blade 207.

In an exemplary embodiment, the side of the grinding blade equipped with blades 601 has a concave shape in the middle.

In an exemplary embodiment, the grinding blade resembles an annular structure.

In an exemplary embodiment, a through-hole is also provided in the middle of the grinding blade.

In an exemplary embodiment, coffee beans sequentially pass through the upper lid 301, the gap adjustment gear plate 302, the upper grinding blade connecting seat 305, and the upper grinding blade 306, ultimately falling into the chamber formed by the upper grinding blade 306 and the lower grinding blade 307.

In an exemplary embodiment, the upper grinding blade connecting seat 305 is further provided with positioning pins 502, which are arranged on the sides of the upper grinding blade connecting seat 305.

In an exemplary embodiment, there are multiple positioning pins 502, for example, three.

In an exemplary embodiment, the positioning pins 502 are evenly distributed along the edge of the upper grinding blade connecting seat 305.

In an exemplary embodiment, the positioning pins 502 match with the main housing 308.

In an exemplary embodiment, the positioning pins 502 further include springs.

In an exemplary embodiment, the main housing 308 has a through-hole in the middle, and its shape is similar to that of the upper housing 303.

In an exemplary embodiment, the main housing 308 encases the upper grinding blade 306 and the lower grinding blade 307; that is, the upper grinding blade 306 and the lower grinding blade 307 are arranged within the main housing 308.

In an exemplary embodiment, one end of the main housing 308 is provided with multiple positioning holes that match the positioning pins 502. It can be understood that the positioning pins 502 fit into the positioning holes, and the upper grinding blade connecting seat 305 is connected to the main housing 308 via the positioning pins 502.

In an exemplary embodiment, the positioning holes are provided on the upper end of the main housing 308, for example, on the inner side walls or inner walls of the upper end.

In an exemplary embodiment, the positioning holes are evenly distributed on the upper end of the main housing 308.

In an exemplary embodiment, since the positioning pins 502 include springs, when the upper grinding blade 306 is pressed, the gap between the upper grinding blade 306 and the lower grinding blade 307 decreases. When the upper grinding blade 306 is not pressed or the pressing force decreases, the gap between the upper grinding blade 306 and the lower grinding blade 307 increases.

In an exemplary embodiment, when the gap adjustment gear plate 302 is rotated, the upper grinding blade 306 moves vertically. As the gap adjustment gear plate 302 rotates, the pins 401 rotate. Due to the matching relationship between the pins 401 and the pin slots 501 on the upper grinding blade connecting seat 305, the upper grinding blade connecting seat 305 moves upward or downward. Since the upper grinding blade 306 is fixedly connected to the upper grinding blade connecting seat 305, rotating the gap adjustment gear plate 302 causes the upper grinding blade 306 to move vertically, thereby achieving the purpose of adjusting the distance between the upper grinding blade 306 and the lower grinding blade 307. By adjusting this distance, the particle size of the coffee powder ground in the grinding chamber can be controlled.

In an exemplary embodiment, optionally, the upper grinding blade connecting seat 305, the upper grinding blade 306, and the lower grinding blade 307 are arranged within the chamber formed by the upper housing 303 and the main housing 308.

In an exemplary embodiment, the lower surface of the lower grinding blade 307 is connected to the fan 310.

In an exemplary embodiment, the fan 310 has a shaft in the middle, which matches the through-hole in the middle of the lower grinding blade 307.

In an exemplary embodiment, a power shaft drives the fan 310 to rotate.

In an exemplary embodiment, the fan 310 cools the lower grinding blade 307, preventing temperature rise during the grinding operation of the upper grinding blade 306 and the lower grinding blade 307, thereby avoiding issues that affect the quality of the coffee powder.

In an exemplary embodiment, the coffee bean grinding mechanism 108 further includes a lower housing 311 that encloses the fan 310.

In an exemplary embodiment, the shape of the lower housing 311 is similar to that of the upper housing 303.

In an exemplary embodiment, an outlet is provided on the side of the main housing 308 to discharge the coffee powder ground between the upper grinding blade 306 and the lower grinding blade 307.

In an exemplary embodiment, by rotating the gap adjustment gear plate 302 using the gap adjustment motor 304, the pins 401 on the gap adjustment gear plate 302 drive the upper grinding blade connecting seat 305 to move up and down, adjusting the upper grinding blade connecting seat 305 upward or downward. This adjusts the upper grinding blade 306 upward or downward, thereby changing the gap between the upper grinding blade 306 and the lower grinding blade 307, and ultimately controlling the particle size of the coffee powder.

In an exemplary embodiment, the power shaft 312 is externally connected to a power device, which drives the power shaft 312 to rotate, thereby driving the fan 310 and the lower grinding blade 307 to rotate.

In an exemplary embodiment, coffee beans are ground into coffee powder within the chamber formed by the upper grinding blade 306 and the lower grinding blade 307.

In an exemplary embodiment, the ground coffee powder is delivered to the coffee powder feeding mechanism 109 through the outlet.

In an exemplary embodiment, the coffee machine of this application further includes a coffee powder feeding mechanism 109.

In an exemplary embodiment, the coffee powder feeding mechanism 109 is located below the outlet of the coffee bean grinding mechanism 108.

In an exemplary embodiment, the coffee powder feeding mechanism 109 is used to deliver coffee powder into the filter basket.

In an exemplary embodiment, a coffee powder receiving hopper is provided above the coffee powder feeding mechanism 109 to receive the coffee powder ground by the coffee bean grinding mechanism 108—that is, the hopper receives the coffee powder from the outlet of the coffee bean grinding mechanism 108.

In an exemplary embodiment, the coffee powder receiving hopper is equipped with a switch valve. When the valve is open, coffee powder can directly fall into the hopper; when the valve is closed, coffee powder cannot enter the hopper and must wait until it is opened again.

In an exemplary embodiment, the coffee powder receiving hopper has a weighing function. When the weight of the coffee powder received reaches the required amount, the valve on the hopper closes.

In an exemplary embodiment, optionally, when the hopper receives the required weight of coffee powder, the coffee bean grinding mechanism 108 stops grinding coffee beans.

In an exemplary embodiment, the coffee powder feeding mechanism 109 is further provided with a coffee powder delivery channel 110.

In an exemplary embodiment, one end of the coffee powder delivery channel 110 connects to the coffee powder receiving hopper, and the other end faces the direction of the filter basket assembly.

In an exemplary embodiment, the coffee powder feeding mechanism 109 delivers the weighed coffee powder into the filter basket through the coffee powder delivery channel 110.

In an exemplary embodiment, as needed, the coffee powder delivery channel 110 can be a tubular channel, such as a hollow circular tube.

In an exemplary embodiment, a piston component is provided within the tubular channel, the piston component being used to deliver coffee powder from within the tubular channel into the powder bowl.

In an exemplary embodiment, the piston component matches the tubular channel.

In an exemplary embodiment, the piston component can also be used to push away coffee residue on the bottom of the bowl.

In an exemplary embodiment, the telescopic length of the piston component can vary as needed. For example, when it is necessary for the piston component to extend forward to clean off coffee residue on the bottom of the bowl, the extension length of the piston component is greater than the length required to merely deliver coffee powder into the bottom of the bowl.

In an exemplary embodiment, before the piston component needs to deliver coffee powder into the bottom of the bowl, it is required that there is no coffee residue on the bottom of the bowl in front of the piston component. If there is coffee residue, the piston component first pushes away the coffee residue; after the coffee residue is pushed away, the basket wall of the powder bowl rises, and then the piston component delivers the coffee powder into the powder bowl. If there is no residue on the bottom of the bowl in front of the piston component, or the basket wall has already risen, it is considered that there is currently no coffee residue, and the piston component can directly deliver the coffee powder into the powder bowl.

In an exemplary embodiment, the tamping mechanism 107 is arranged above the outlet end of the coffee powder delivery channel 110, that is, the tamping mechanism 107 does not obstruct the delivery of coffee powder into the powder bowl.

In an exemplary embodiment, the worktable 102 is also provided with through-holes, the number of through-holes being the same as the number of group heads.

In an exemplary embodiment, the through-holes are located below the group heads; for example, the through-holes are directly beneath the group heads.

In an exemplary embodiment, optionally, on the worktable 102, through-holes are provided directly below both the first group head 106 and the second group head 111.

In an exemplary embodiment, of course, as needed, there may be only one through-hole. When there is only one through-hole, a groove is provided on the worktable, the groove being connected to the through-hole; the coffee liquid extracted from the powder bowl enters the groove and then flows out through the through-hole on the worktable 102.

In an exemplary embodiment, the groove is arranged, for example, between two guide rails, and the length of the groove does not exceed the length of the guide rails.

In an exemplary embodiment, when the powder bowl moves directly below the group head, the powder bowl through-hole connects with the through-hole; for example, when the first powder bowl 104 moves below the first group head 106, the powder bowl through-hole beneath the first powder bowl 104 connects with the through-hole on the worktable 102; when the first group head 106 extracts the coffee puck located within the first powder bowl 104, the extracted coffee liquid flows out through the through-hole corresponding to the first group head 106, or it can be understood that the user ultimately obtains the coffee liquid through the through-hole on the worktable 102.

In an exemplary embodiment, the coffee machine of the present application further comprises a water supply device.

In an exemplary embodiment, the water supply device is connected to the group head.

In an exemplary embodiment, the water supply device is arranged at the rear of the coffee machine host 101; as needed, the water supply device may also be arranged on the side or top of the coffee machine host 101.

In an exemplary embodiment, the water supply device comprises a heating block 202 and a water supply pipeline.

In an exemplary embodiment, the water supply pipeline passes through the heating block 202 in an S-shaped configuration.

In an exemplary embodiment, the water supply pipeline continuously passes through the heating block 202 in an S-shaped configuration.

In an exemplary embodiment, multiple heating rods are arranged on the heating block 202.

In an exemplary embodiment, the multiple heating rods are evenly distributed around the water supply pipeline and can continuously provide hot water.

In an exemplary embodiment, the water supply device further comprises a piston pump unit 203.

In an exemplary embodiment, the piston pump unit 203 is connected to the water supply pipeline; for example, the piston pump unit 203 is connected to the water supply pipeline within the heating block 202.

In an exemplary embodiment, the piston pump unit 203 comprises a piston module.

In an exemplary embodiment, the piston module comprises a camshaft 701 and pistons arranged on both sides of the camshaft 701.

In an exemplary embodiment, the piston pump unit 203 further comprises a water pump driving motor 703 and a water pump driving module 704.

In an exemplary embodiment, the water pump driving motor 703 is directly or indirectly connected to the camshaft 701.

In an exemplary embodiment, the water pump driving module 704 is used to control the water pump driving motor 703, for example, to control the uniform acceleration and constant speed of the water pump driving motor 703.

In an exemplary embodiment, the camshaft 701 is cylindrical, and one end of the camshaft 701 is provided with a threaded structure; the end of the camshaft 701 with the threaded structure is connected to the water pump driving motor 703. Of course, the camshaft 701 may optionally be connected to the water pump driving motor 703 via gears, that is, the water pump driving motor 703 directly or indirectly drives the camshaft 701.

In an exemplary embodiment, an annular guide rail is provided on the camshaft 701, the annular guide rail being elliptical.

In an exemplary embodiment, at both ends of the maximum diameter of the elliptical annular guide rail, one end is close to the end of the camshaft 701 provided with the threaded structure, and the other end is close to the opposite end of the camshaft 701 corresponding to the threaded structure.

In an exemplary embodiment, fixing blocks 803 are arranged on both sides of the annular guide rail, the fixing blocks 803 being connected to the pistons; for example, the fixing blocks 803 are fixedly connected to the piston rods of the pistons.

In an exemplary embodiment, it further includes fixing rods, the fixing rods being connected to the heating block 202, for example, fixedly connected, and there are multiple fixing rods.

In an exemplary embodiment, the fixing blocks 803 are movably sleeved on the fixing rods.

In an exemplary embodiment, the number of fixing blocks 803 is the same as the number of pistons; it can be understood that one end of each piston is fixedly connected to a fixing block 803.

In an exemplary embodiment, the fixing blocks 803 are connected to the annular guide rail on the camshaft 701 via sliders 802; or it can be understood that when the camshaft 701 rotates, the sliders 802 arranged on both sides of the camshaft 701 move within the annular guide rail, and the sliders 802 further drive the pistons to move back and forth.

In an exemplary embodiment, the piston heads of the pistons match the water flow channel assembly arranged within the heating block 202.

In an exemplary embodiment, a water flow channel assembly 707 is arranged on the heating block 202.

In an exemplary embodiment, a water valve group 705 is arranged on the water flow channel assembly 707.

In an exemplary embodiment, the pistons include a second piston 702 and a first piston 708.

In an exemplary embodiment, the heating block 202 is provided with piston holes, the piston holes matching the pistons.

In an exemplary embodiment, the piston holes are connected to a chamber.

In an exemplary embodiment, the water valve group 705 is provided with a water inlet 901, that is, the water within the S-shaped water supply pipeline in the heating block 202 is all obtained through the water inlet 901.

In an exemplary embodiment, the water valve group 705 is further provided with a water inlet channel, the water inlet channel being connected to the water inlet 901.

In an exemplary embodiment, the water inlet channel is connected to a first water inlet valve 903 and a second water inlet valve 904.

In an exemplary embodiment, the first water inlet valve 903 and the second water inlet valve 904 are both one-way valves.

In an exemplary embodiment, a chamber is provided within the water flow channel assembly 707.

In an exemplary embodiment, the chamber serves to connect the water inlet 901 with the piston hole.

In an exemplary embodiment, the chamber is further connected with an inlet valve and an outlet valve.

In an exemplary embodiment, both the inlet valve and the outlet valve are one-way valves.

In an exemplary embodiment, optionally, both the inlet valve and the outlet valve can be arranged on the water valve group 705.

In an exemplary embodiment, the inlet valves include a first inlet valve 903 and a second inlet valve 904.

In an exemplary embodiment, the outlet valves include a first outlet valve 902 and a second outlet valve 905.

In an exemplary embodiment, when the first piston 708 moves in a direction away from its corresponding piston hole, the pressure within the first chamber 908 decreases, and water in the inlet channel enters the first chamber 908 via the first inlet valve 903; when the first piston 708 presses into its corresponding piston hole, the water within the first chamber 908 flows out through the first outlet valve 902, and then enters the S-shaped water supply pipeline arranged within the heating block 202—that is, the first outlet valve 902 communicates with the S-shaped water supply pipeline within the heating block 202.

In an exemplary embodiment, when the second piston 702 moves in a direction away from its corresponding piston hole, the pressure within the second chamber 909 decreases, and water in the inlet channel enters the second chamber 909 via the second inlet valve 904; when the second piston 702 presses into its corresponding piston hole, the water within the second chamber 909 flows out through the second outlet valve 905, and then enters the S-shaped water supply pipeline arranged within the heating block 202—that is, the second outlet valve 905 communicates with the S-shaped water supply pipeline within the heating block 202.

In an exemplary embodiment, the design of alternately driving hot water within the water supply pipeline using dual pistons achieves the purpose of dual-channel water output, making the water output within the supply pipeline more stable, thereby ensuring the uniform supply of hot water during subsequent extraction.

In an exemplary embodiment, the workflow of the piston pump unit 203 is as follows: the water pump driving module 704 controls the water pump driving motor 703 to operate, the water pump driving motor 703 drives the camshaft 701, and the camshaft 701 drives the pistons on both sides to move; the pistons on both sides work alternately, with one advancing and one retracting; water in the inlet 901 is stably and uniformly heated through the S-shaped water supply pipeline within the heating block 202, and finally extracts the coffee powder via the group head.

In an exemplary embodiment, the heating block 202 further includes an outlet 907, and the hot water in the S-shaped water supply pipeline within the heating block 202 flows out through the outlet 907, finally flowing out via the group head.

In an exemplary embodiment, the outlet 907 is also connected to a pressure sensor 906.

In an exemplary embodiment, the water pump driving motor 703 is, for example, a servo motor.

In an exemplary embodiment, by adjusting the rotational speed of the water pump driving motor 703, the flow rate of hot water within the water supply pipeline can be adjusted; it can be understood that both the flow rate and the volume of hot water within the supply pipeline can be adjusted by the rotational speed and operating time of the water pump driving motor 703.

In an exemplary embodiment, optionally, the rotation of the water pump driving motor 703 can be uniformly accelerated during the startup phase, and upon reaching a preset first rotational speed threshold, it enters a constant speed state. That is, when the water pump driving motor 703 starts, the water output from the group head begins slowly and accelerates uniformly, then outputs at a constant speed until the preset water volume is dispensed, and then stops water output.

In an exemplary embodiment, the preset first rotational speed threshold of the water pump driving motor 703 is 2-6 ml/s; for example, the rotational speed of the water pump driving motor 703 is 4.5 ml/s.

In an exemplary embodiment, optionally, the water supply device may also include a water storage tank 201, which is used to store preheated warm water. The purpose of providing the water storage tank 201 is to rapidly supply the group head with water at the appropriate temperature; for example, during winter or when the ambient temperature is very low, relying solely on the heating of the heating block 202 may not quickly meet user needs. The preheated water in the water storage tank 201 significantly reduces the heating time of the heating block 202, enabling timely response to user demands.

In an exemplary embodiment, the water temperature within the water storage tank 201 is, for example, 40° C. to 80° C.

In an exemplary embodiment, the water storage tank 201 is arranged on the back of the coffee machine host 101; of course, if necessary, it may also be arranged on the side or top of the coffee machine host 101.

In an exemplary embodiment, one end of the water storage tank 201 is connected to an external water source, and the other end is connected to the water supply pipeline within the heating block 202; the other end of the water supply pipeline connects to the group head.

In an exemplary embodiment, optionally, a temperature control module is also included.

In an exemplary embodiment, the temperature control module adjusts the heating power of the heating block 202 according to instructions, thereby achieving the purpose of adjusting the water temperature within the water supply pipeline; of course, if the terminal does not have specific requirements for water temperature, it can default to heating to 92° C.-94° C., i.e., with constant heating power.

In an exemplary embodiment, optionally, a control module is also provided, which is used to match the corresponding weight of coffee powder and hot water volume according to the user's desired coffee liquid volume and concentration.

In an exemplary embodiment, as needed, the control module is further provided with a touch screen, through which the user sets parameters.

In an exemplary embodiment, optionally, below the coffee machine host 101, there is also a residue collection tank 112, which is located in front of the tamping mechanism 107; that is, when coffee residue is pushed off from the bottom of the bowl, it falls into the residue collection tank 112.

In an exemplary embodiment, optionally, the residue collection tank 112 can also be used to collect falling waste liquid.

### Embodiment 2

FIG. 7 is a schematic flowchart illustrating a method for extracting coffee liquid according to an embodiment of the present application. The following description will provide a detailed explanation of this method with reference to FIG. 7.

The coffee liquid extraction method of this embodiment employs the aforementioned coffee machine or is applied to it.

First, in step 1001, an instruction to extract coffee liquid is received.

In an exemplary embodiment, the instruction to extract coffee liquid is received from a user or operator.

In an exemplary embodiment, the extraction instruction includes information such as the desired volume and concentration of the coffee liquid.

In an exemplary embodiment, if there is no specific requirement for the temperature of the coffee liquid, it defaults to 92° C.-94° C., as this temperature range yields the optimal taste.

In an exemplary embodiment, if a specific temperature is required for the coffee liquid, the temperature can be adjusted according to the instruction.

In an exemplary embodiment, the temperature adjustment of the coffee liquid can be achieved by modifying the heating power of the heating block.

In an exemplary embodiment, the extraction instruction can be obtained through control buttons on the coffee machine or remotely via an APP, meaning the coffee machine is equipped with a remote instruction receiving unit.

In step 1002, coffee beans are ground, and a corresponding volume of hot water is heated according to the extraction instruction.

In an exemplary embodiment, upon receiving the extraction instruction, the coffee bean grinding mechanism is activated to grind the coffee beans.

In an exemplary embodiment, a corresponding volume of hot water is heated based on the extraction instruction.

In an exemplary embodiment, optionally, the particle size of the coffee powder can be adjusted according to the extraction instruction.

In an exemplary embodiment, the ground coffee powder is delivered to the coffee powder feeding mechanism.

In an exemplary embodiment, when the coffee powder feeding mechanism has acquired the amount of coffee powder corresponding to the extraction instruction, grinding of the coffee beans is halted. For example, if the extraction instruction requires 20 grams of coffee powder, grinding stops when the feeding mechanism has obtained 20 grams, and the coffee bean grinding mechanism waits for the next instruction.

In step 1003, it is determined whether there is coffee residue on the basket base beneath the tamping mechanism. If yes, the coffee powder feeding mechanism pushes the residue off the basket base. If no, the basket wall corresponding to the basket base rises, and the feeding mechanism delivers the specified amount of coffee powder into the powder bowl.

In an exemplary embodiment, the presence of coffee residue on the basket base beneath the tamping mechanism is checked.

In an exemplary embodiment, typically, when the powder bowl moves beneath the tamping mechanism, the basket wall is concealed within the powder bowl assembly. The basket wall rises only when there is no residue on the basket base. Alternatively, the basket wall may already be raised when the powder bowl enters beneath the tamping mechanism and lowers after full entry, hiding until the basket base is free of residue, at which point it rises again.

In an exemplary embodiment, if coffee residue is present on the basket base beneath the tamping mechanism, the feeding mechanism pushes it off.

In an exemplary embodiment, when no residue is detected, the corresponding basket wall rises, and the feeding mechanism delivers the required amount of coffee powder into the powder bowl.

In step 1004, the tamping mechanism compresses the coffee powder in the powder bowl into a coffee puck.

In an exemplary embodiment, the tamping mechanism applies pressure to the powder bowl located beneath it, compressing the coffee powder into a puck.

In an exemplary embodiment, the applied pressure is approximately 15 kilograms.

In an exemplary embodiment, compressing the coffee powder serves to flatten it and form it into a puck shape, as the extraction process targets the coffee puck rather than loose coffee powder.

In step 1005, the powder bowl moves beneath an idle group head.

In an exemplary embodiment, the powder bowl containing the coffee puck is moved to a position beneath an available group head. This involves identifying which group head is free and positioning the powder bowl accordingly.

In step 1006, hot water is used to extract the coffee puck via the group head.

In an exemplary embodiment, the group head releases hot water to extract the coffee puck beneath it.

In an exemplary embodiment, optionally, before the extraction-specifically, before moving the powder bowl beneath the idle group head—the cold water in the water supply pipeline between the group head and the heating block is discharged through the group head. For example, the cold water is expelled before positioning the powder bowl beneath the group head.

In an exemplary embodiment, optionally, an insulating layer is provided around the external surface of the water supply pipeline between the group head and the heating block.

In an exemplary embodiment, the extraction can be performed by drip filtration or spraying the coffee puck using the group head.

In an exemplary embodiment, the hot water released by the group head is driven through the water supply pipeline by a piston pump.

In an exemplary embodiment, once the required volume of hot water has completely flowed out from the group head, the piston pump ceases operation.

### Embodiment 3

The present invention also provides a computer-readable storage medium storing one or more programs comprising instructions that, when executed by a portable electronic device containing multiple applications, enable the device to perform the methods illustrated in the accompanying drawings, specifically executing the steps of the aforementioned coffee liquid extraction method.

Although the embodiments disclosed herein are described above, they are presented solely to facilitate understanding of the invention and are not intended to limit its scope. Any person skilled in the technology may make modifications and changes in form and detail without departing from the spirit and scope of the disclosed invention. The scope of patent protection for the present invention should be defined by the appended claims.

What is claimed is:

1. A coffee machine, comprising: a coffee machine host provided with a worktable; a filter basket assembly that performs reciprocating motion on the worktable; the filter basket assembly includes a filter basket used for holding coffee powder; a group head arranged above the filter basket assembly; a tamping mechanism arranged on the side of the group head; the tamping mechanism is used to compress the coffee powder within the filter basket; the coffee machine host further includes: a coffee powder feeding mechanism and a coffee bean grinding mechanism; the coffee powder feeding mechanism is used to deliver coffee powder into the filter basket; the coffee bean grinding mechanism is used to grind coffee beans into coffee powder and deliver the coffee powder into the coffee powder feeding mechanism; a water supply device connected to the group head; the water supply device further includes: a piston pump unit, which is connected to the water supply pipeline; the piston pump unit includes two pistons that alternately drive hot water in the water supply pipeline into the group head; the group head is used to extract the coffee powder in the filter basket that has moved directly below the group head.

2. The coffee machine according to claim 1, wherein the group head includes a first group head and a second group head; the first group head and the second group head are arranged on both sides of the tamping mechanism.

3. The coffee machine according to claim 2, wherein: the worktable is provided with guide rails, and the filter basket assembly performs reciprocating motion on the guide rails; the worktable is provided with a through-hole located below the group head.

4. The coffee machine according to claim 3, wherein: the filter basket includes a basket base and a basket wall; the basket base has a mesh base; the basket wall is liftable; when the basket wall rises from within the filter basket assembly, the basket wall and the basket base together form the filter basket; after the basket wall descends, it is hidden within the filter basket assembly; the filter basket includes a single wall filter basket and a double wall filter basket.

5. The coffee machine according to claim 4, wherein: the filter basket assembly is provided with a filter basket through-hole; when the filter basket moves directly below the group head, the filter basket through-hole connects with the through-hole on the worktable.

6. The coffee machine according to claim 5, wherein: the water supply device includes a heating block and a water supply pipeline; the water supply pipeline passes through the heating block in an S-shape; the heating block is provided with multiple heating rods; the multiple heating rods are evenly distributed around the water supply pipeline.

7. The coffee machine according to claim 6, wherein the water outlet of the group head is shaped like a showerhead.

8. A method for extracting coffee liquid, using the coffee machine according to claim 1, comprising:
receiving an instruction to extract coffee liquid;
grinding coffee beans and heating a corresponding volume of hot water according to the instruction to extract coffee liquid;
determining whether there is coffee residue on the basket base below the tamping mechanism: if yes, the coffee powder feeding mechanism pushes the coffee residue off the basket base; if no, the basket wall corresponding to the basket base rises, and the coffee powder feeding mechanism delivers coffee powder of the weight corresponding to the instruction into the filter basket;
the tamping mechanism compresses the coffee powder in the filter basket into a coffee puck;
the filter basket moves to an idle group head below;
the hot water passes through the group head to extract the coffee puck.

9. The method for extracting coffee liquid according to claim 8, wherein when the coffee powder feeding mechanism has obtained the coffee powder of the weight corresponding to the instruction to extract coffee liquid, the coffee bean grinding mechanism stops grinding coffee beans.

10. The method for extracting coffee liquid according to claim 8, wherein extracting the coffee puck with the group head includes: the group head performs drip filtration or spraying on the coffee puck.
